(19) United States
(12) Patent Application Publication
(10) Pub. No.: US 2012/0114163 A1
(43) Pub. Date: May 10, 2012

(54) SPEAKER SYSTEM INCLUDING A SPEAKER DEVICE HAVING A SPEAKER UNIT MOUNTED WITH AN ANTENNA

(76) Inventor: Chung-Yen YANG, New Taipei City (TW)

(21) Appl. No.: 13/086,720

(22) Filed: Apr. 14, 2011

(30) Foreign Application Priority Data
Nov. 9, 2010 (TW) 099138483

(51) Int. Cl. H04R 1/02; H04R 25/00

(52) U.S. Cl. 381/386; 381/150

(57) ABSTRACT

A speaker system includes a circuit board and a speaker device disposed on the circuit board. The speaker device includes a speaker unit for generating an audio output, and an antenna directly mounted on the speaker unit for radiating and receiving radio waves.

### CROSS-REFERENCE TO RELATED APPLICATION

This application claims priority of Taiwanese Application No. 099138483, filed on Nov. 9, 2010.

### BACKGROUND OF THE INVENTION

1. Field of the Invention

The present invention relates to a speaker system, more particularly to a speaker system including a speaker device having a speaker unit mounted with an antenna.

2. Description of the Related Art

Currently, it is desired to design a communication device (such as a cell phone, a global positioning system, etc.) having various functions and a relatively smaller size for satisfying the market trend and the user requirement.

For example, an antenna of a cell phone is either disposed on a system board of the cell phone, or is additionally disposed in the cell phone. However, for the various functions, the system board of the cell phone is provided with several electronic modules associated with respective functions, such as a speaker for generating an audio output, a processor for computing and controlling other electronic modules, etc. Therefore, it is unavoidable that an accommodating space for other electronic modules will be decreased and wiring layout will be relatively complicated if the system board is additionally provided with an antenna.

### SUMMARY OF THE INVENTION

Therefore, an object of the present invention is to provide a speaker system including a speaker device having a speaker unit mounted with an antenna.

Accordingly, a speaker system of the present invention comprises a circuit board and a speaker device disposed on the circuit board. The speaker device includes a speaker unit for generating an audio output, and an antenna directly mounted on the speaker unit for radiating and receiving radio waves.

Preferably, the speaker unit of the speaker device includes a housing having a top wall formed with a hole portion, and an audio output module disposed in the housing and exposed from the hole portion for generating the audio output. The antenna is directly mounted on an outer surface of the top wall, or is embedded in the housing. Alternatively, the housing further has a peripheral wall portion, and the antenna is directly mounted on an outer surface of the peripheral wall portion and surrounds the peripheral wall portion.

In one embodiment, the speaker unit of the speaker device includes a base component, and an audio output module disposed on the base component for generating the audio output. The antenna is directly mounted on the audio output module.

Preferably, the antenna of the speaker device includes a radiator segment that is directly mounted on the speaker unit and that surrounds at least a portion of the speaker unit. The speaker unit of the speaker device includes a base component, and an audio output module disposed on the base component for generating the audio output. The antenna further includes a feed-in segment and a grounded segment. The feed-in segment has a connection end electrically connected to the radiator segment, and a feed-in end opposite to the connection end and extending toward the base component. The grounded segment is spaced apart from and extending parallel to the feed-in segment, and has a connection end electrically connected to the radiator segment and a grounded end extending toward the base component.

The radiator segment is substantially formed into a loop, and includes a first radiator section extending in a first direction, a second radiator section extending from one end of the first radiator section in a second direction substantially transverse to the first radiator section, a third radiator section extending from one end of the second radiator section opposite to the first radiator section and substantially parallel to the first radiator section, and a fourth radiator section extending from one end of the third radiator section opposite to the second radiator section and substantially parallel to the second radiator section. The first and fourth radiator sections have distal ends spaced apart from each other.

Preferably, the antenna is a planar antenna.

Preferably, the circuit board includes a bonding pad, an inductor electrically connected to the bonding pad for configuring a resonance point of the audio output generated by the speaker unit of the speaker device, and a control unit electrically connected to the inductor for generating an audio signal. The speaker unit is electrically connected to the bonding pad for receiving the audio signal from the control unit so as to generate the audio output.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating a first preferred embodiment of a speaker system according to the present invention;

FIG. 2 is a perspective view of a speaker device of the speaker system of the first preferred embodiment;

FIG. 3 is an exploded perspective view of a speaker unit of the speaker device of the speaker system of the first preferred embodiment;

FIG. 4 is a perspective view of another example of the speaker device of the speaker system of the first preferred embodiment;

FIG. 5 is a perspective view of a further example of the speaker device of the speaker system of the first preferred embodiment;

FIG. 6 is a block diagram illustrating components disposed on a circuit board of the speaker system of the first preferred embodiment;

FIG. 7 is a plot to illustrate measurement data of return loss of signal power associated with an antenna of the speaker device during the operation of the speaker unit;

FIG. 8 is a plot to illustrate measurement data of voltage standing wave ratios associated with the antenna of the speaker device during the operation of the speaker unit;

FIG. 9 is a top view of a radiation pattern associated with the antenna operating under 2.45 GHz;

FIG. 10 is a bottom view of a radiation pattern associated with the antenna operating under 2.45 GHz;

FIG. 11 is a side view of a radiation pattern associated with the antenna operating under 2.45 GHz;

FIG. 12 is a perspective view of a second preferred embodiment of a speaker device of a speaker system according to the present invention; and

FIG. 13 is a perspective view of a third preferred embodiment of a speaker device of a speaker system according to the present invention.

### DETAILED DESCRIPTION OF THE PREFERRED EMBODIMENTS

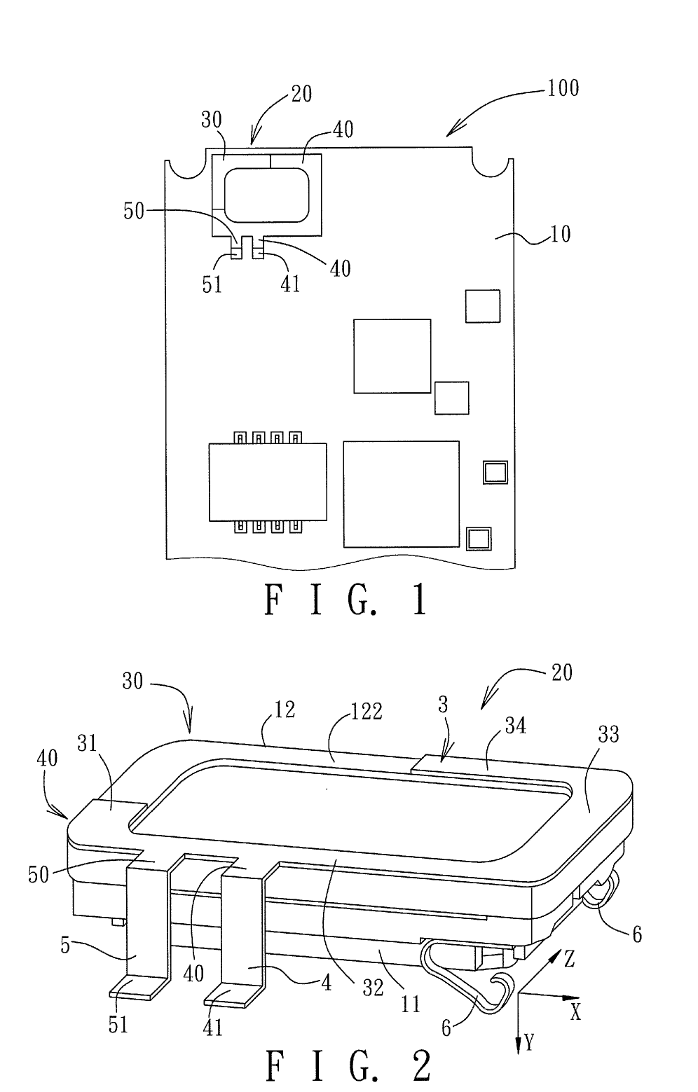

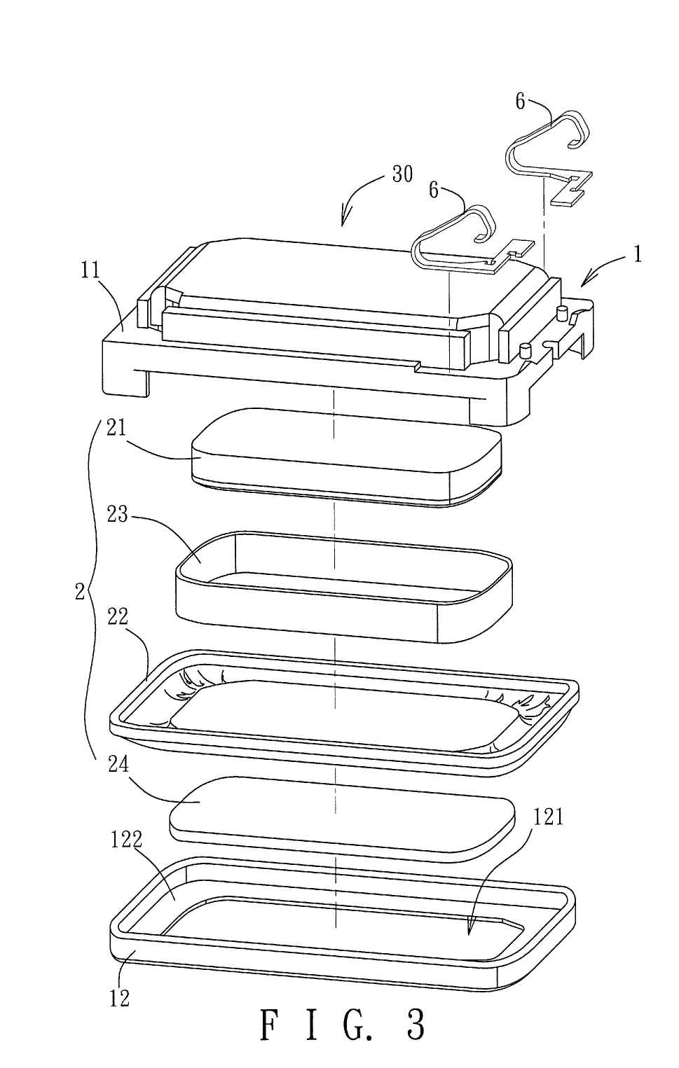

Referring to FIGS. 1 to 3, a first preferred embodiment of a speaker system 100 of this invention is configured for application to various portable electronic devices, such as a smart phone, a cell phone, a notebook computer, a personal navigation device, a global positioning system, etc. The speaker system 100 includes a circuit board 10, and a speaker device 20 disposed on the circuit board 10. The speaker device 20 includes a speaker unit 30 for generating an audio output, and an antenna 40 directly mounted on the speaker unit 30 for radiating and receiving radio waves.

The speaker unit 30 includes a housing 1, an audio output module 2 disposed in the housing 1 for generating an audio output, and a pair of connecting components 6 mounted on the housing 1. The housing 1 is made of an insulating material (e.g. plastics), and includes a base component 11 disposed on the circuit board 10, and a cover component 12 connected to the base component 11 so as to define an accommodating space therebetween. The cover component 12 is substantially in a rectangular shape, and includes a top wall 122 formed with a hole portion 121. The connecting components 6 are metallic hooks configured for electrically connecting with the circuit board 10 so as to transmit an audio signal from the circuit board 10 to the audio output module 2 for generating the audio output.

The audio output module 2 is disposed in the accommodating space in the housing 1, and includes a magnetic component 21, a voice coil module 22, a surrounding component 23, and a diaphragm 24. The magnetic component 21 is a magnet, and is disposed in the base component 11 of the housing 1. The voice coil module 22 is disposed between the magnetic component 21 and the cover component 12 of the housing 1, and includes a coil (not shown) electrically connected to the connecting components 6. The voice coil module 22 is adjacent to the magnetic component 21 so as to provide a motive force with respect to the magnetic component 21 when the voice coil module 22 receives the audio signal from the circuit board 10 to generate a magnetic field. The surrounding component 23 is made of an elastic material, and is configured to surround and receive the magnetic component 21. The diaphragm 24 is disposed between the voice coil module 22 and the cover component 12 of the housing 1, and is exposed from the hole portion 121 in the cover component 12. The diaphragm 24 covers the voice coil module 22 such that the voice coil module 22 is capable of driving the diaphragm 24 to vibrate to generate the audio output when the voice coil module 22 provides the motive force with respect to the magnetic component 21 and moves with respect to the magnetic component 21.

In this embodiment, the antenna 40 is, but not limited to, a planar inverted F antenna (PIFA). The antenna 40 includes a radiator segment 3 that is directly mounted on an outer surface of the top wall 122 of the cover component 12 and that surrounds the hole portion 121 of the cover component 12. The antenna 40 further includes a feed-in segment 4 and a grounded segment 5 that are electrically connected to the radiator segment 3. The radiator segment 3 includes first, second, third and fourth radiator sections 31 to 34. The first radiator section 31 extends in a (Z) direction. The second radiator section 32 extends from one end of the first radiator section 31 in an (X) direction substantially transverse to the first radiator section 31. The third radiator section 33 extends from one end of the second radiator section 32 opposite to the first radiator section 31 and substantially parallel to the first radiator section 31. The fourth radiator section 34 extends from one end of the third radiator section 33 opposite to the second radiator section 32 and substantially parallel to the second radiator section 32.

The first and third radiator sections 31, 33 are disposed on opposite width sides of the cover component 12, respectively. The second and fourth radiator sections 32, 34 are disposed on opposite length sides of the cover component 12, respectively. The first and fourth radiator sections 31, 34 have distal ends spaced apart from each other so as to define a gap associated with an operating band. In practice, a length of the radiator segment 3 is equal to one fourth of a wavelength of an electro-magnetic signal, and the operating band of the antenna 40 ranges from 1 GHz to 6 GHz. In this embodiment, the operating band of the antenna 40 is a 2.4 GHz frequency band suitable for application to wireless local area networks (WLAN). In other embodiments, the operating band of the antenna 40 may be different in order to conform with different applications, such as wireless fidelity (Wi-Fi), world interoperability for microwave access (WiMAX), Bluetooth, global positioning system (GPS), global system for mobile communications (GSM), wideband code division multiple access (WCDMA), etc.

The feed-in segment 4 has a connection end 40 electrically connected to the second radiator section 32 of the radiator segment 3, and a feed-in end 41 opposite to the connection end 40 and extending toward the base component 11 in a (Y) direction for electrically connecting with the circuit board 10. The grounded segment 5 is spaced apart from and extends parallel to the feed-in segment 4, and has a connection end 50 electrically connected to the second radiator section 32 and a grounded end 51 extending toward the base component 11 for electrically connecting with the circuit board 10. It should be appreciated that positions of the feed-in segment 4 and the grounded segment 5 are not limited to the present disclosure.

In this embodiment, the antenna 40 is made of a metallic material, and the radiator segment 3, the feed-in segment 4 and the grounded segment 5 are formed as a single piece. After the antenna 40 is manufactured, the antenna 40 is directly mounted on the outer surface of the top wall 122 of the cover component 12 such that the antenna 40 is integrated with the speaker unit 30. Thus, the circuit board 10 does not need an additional space for the antenna 40. Further, since the antenna 40 is directly mounted on the speaker unit 30 after manufacture, the structure of the antenna 40 may be modified for satisfying various requirements, and the structure of the speaker unit 30 does not need to be modified. Thus, manufacturing cost of the speaker unit 30 will not be increased.

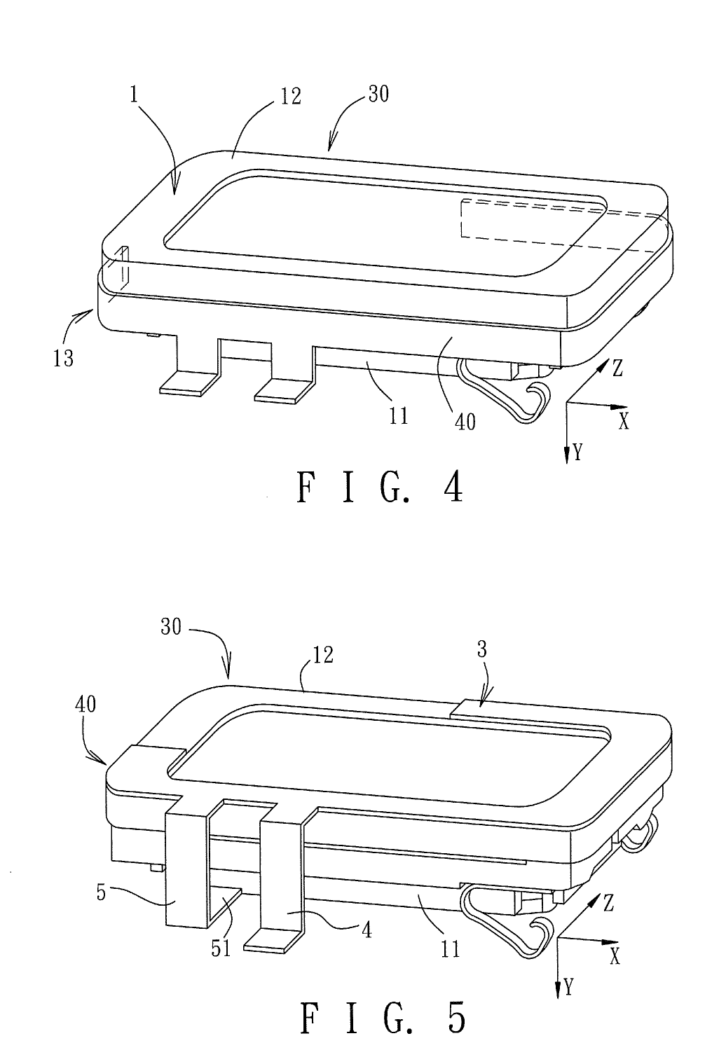

It should be noted that the position of the antenna 40 with respect to the speaker unit 30 is not limited to the disclosure in this embodiment. For instance, the antenna 40 could be mounted on and disposed to surround an outer surface of a peripheral wall portion 13 of the housing 1 as shown in FIG. 4. In this example, the antenna 40 is mounted on the outer surface of the peripheral wall portion 13 of the base component 11. However, the antenna 40 may also be mounted on an outer surface of a peripheral wall portion of the cover component 12. Moreover, the antenna 40 may be engaged with, welded to, or glued to the housing 1 of the speaker unit 30, and other mechanisms may be also used for connecting the antenna 40 to the housing 1.

Additionally, referring to FIG. 5, the grounded end 51 of the grounded segment 5 may be electrically connected to the base component 11 of the housing 1 such that the grounded segment 5 may be electrically connected to a system ground on the circuit board 10 through the speaker unit 30. Thus, an amount of pins disposed on the circuit board 10 can be decreased.

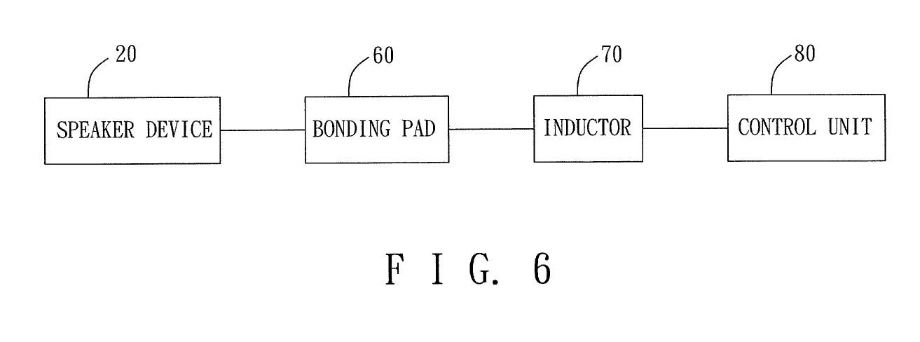

Referring to FIG. 6, the circuit board 10 includes a bonding pad 60, an inductor 70, and a control unit 80. The speaker device 20 is welded to the bonding pad 60 so as to be electrically connected to the circuit board 10. In practice, the circuit board 10 may include a plurality of the bonding pads 60, and the number of the bonding pads 60 corresponds to the number of pins of the speaker device 20. Since the audio output module 2 of the speaker unit 30 will vibrate during operation, in order to ensure the normal operation of the antenna 40, the inductor 70 is electrically connected between the bonding pad 60 and the control unit 80 so as to configure a resonance point of the audio output to be away from the operating band of the antenna 40. The control unit 80 is operable to generate the audio signal and to transmit the audio signal to the audio output module 2 through the bonding pad 60 and the connecting components 6 for generating the audio output.

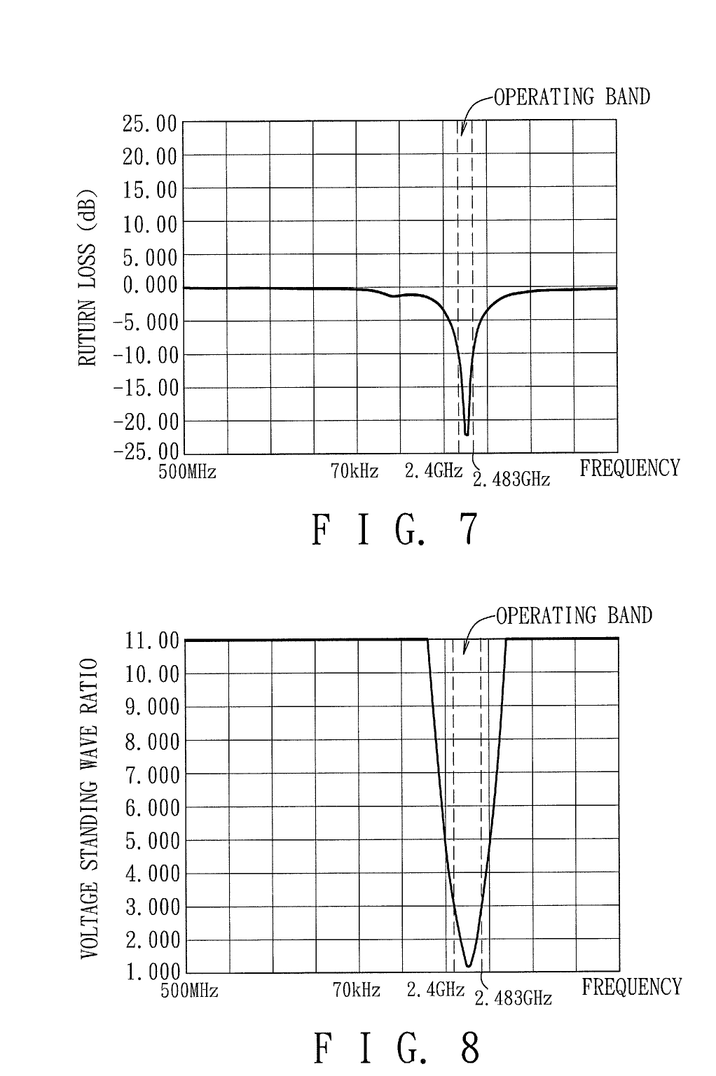

FIG. 7 illustrates measurement data of return loss of signal power associated with the antenna 40 during operation of the speaker unit 30. It can be seen that an impedance bandwidth corresponding to the measurement value −10 dB of the return loss of the antenna 40 is about 83 MHz between the frequencies of 2.4 GHz and 2.483 GHz. Therefore, a basic requirement of radiation efficiency of the antenna 40 may be achieved, and performance of the antenna 40 also conforms with the standards of 2.4 GHz WLAN and the standards 802.11b/g/n of Institute of Electrical and Electronics Engineers (IEEE).

FIG. 8 illustrates measurement data of the voltage standing wave ratio (VSWR) associated with the antenna 40 during the operation of the speaker unit 30. Further, the total radiated power (TRP), the effective isotropic radiated power (EIRP), and the radiation efficiency that are associated with the antenna 40 operating between 2.4 GHz and 2.483 GHz are shown in Table 1. It can be seen that the VSWR of the antenna 40 with respect to the operating band (i.e., between 2.4 GHz and 2.483 GHz) is smaller than 3.

TABLE 1

| Frequency(GHz) | TRP(dBm) | EIRP(dBm) | Radiation Eff.(%) |
|---|---|---|---|
| 2.4 | −2.01 | 1.53 | 62.95 |
| 2.425 | −2.01 | 1.09 | 62.95 |
| 2.45 | −1.97 | 1.41 | 63.53 |
| 2.483 | −2.87 | 0.43 | 51.64 |

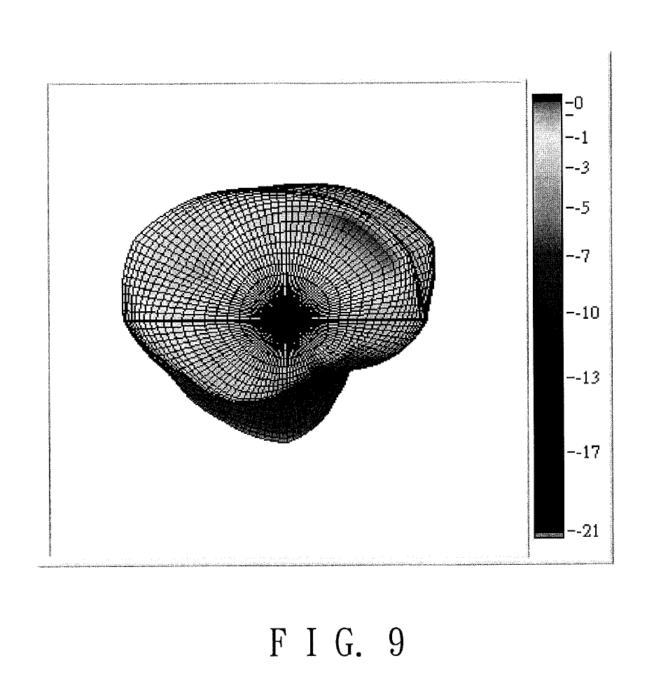

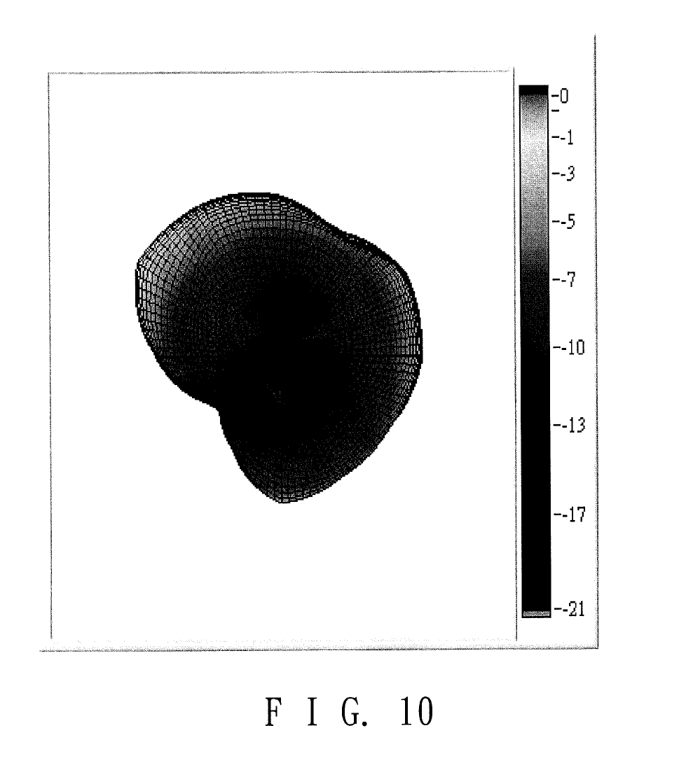

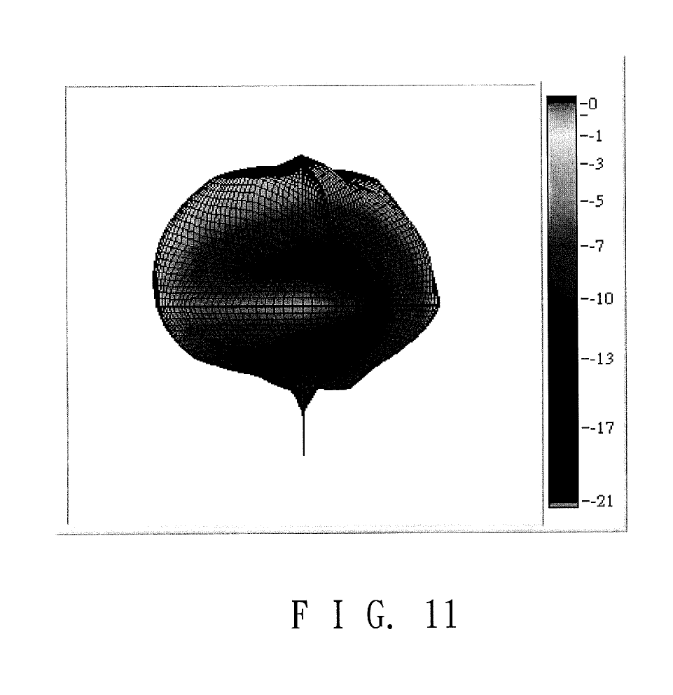

FIGS. 9 to 11 illustrate a three-dimensional radiation pattern associated with the antenna 40 operating under 2.45 GHz. FIG. 9 is a top view of the radiation pattern, FIG. 10 is a bottom view of the radiation pattern, and FIG. 11 is a side view of the radiation pattern. From FIGS. 9 to 11, the antenna 40 of the speaker system 100 still has relatively high antenna gain and omni-directionality when the speaker unit 30 is operating. Accordingly, the speaker system 100 can be applied to an electronic device for WLAN.

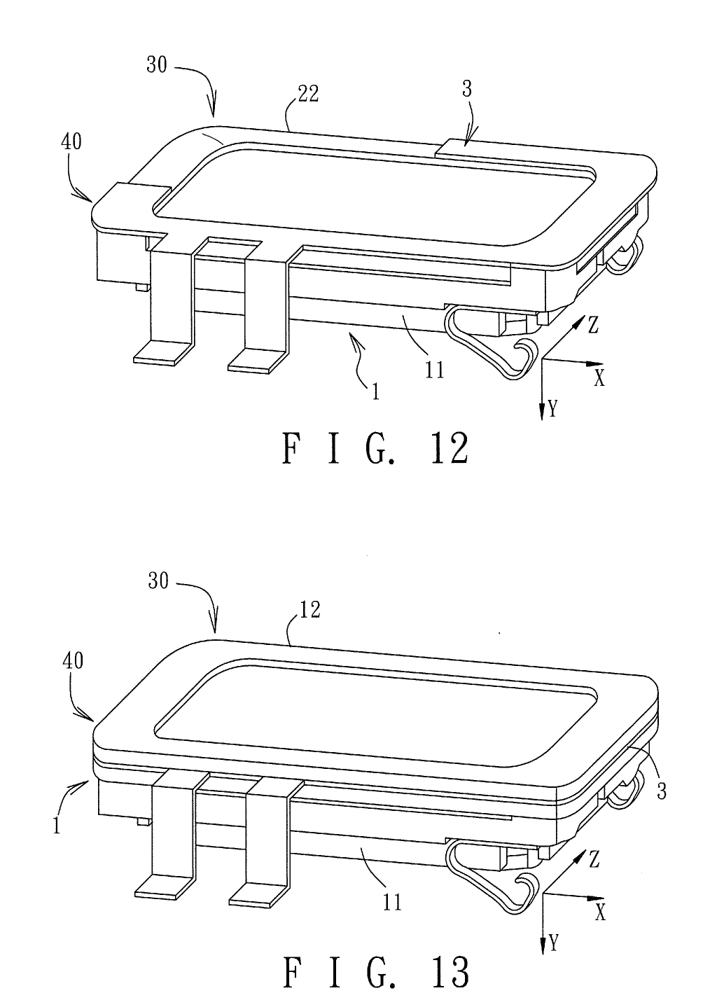

Referring to FIG. 12, a second preferred embodiment of the speaker system 100 according to the present invention is similar to the first preferred embodiment. In the second preferred embodiment, the housing 1 of the speaker unit 30 only includes a base component 11, and the antenna 40 is directly mounted on the audio output module 2. Particularly, the radiator segment 3 of the antenna 40 is directly mounted on an outer surface of the voice coil module 22 instead of the cover component 12 of the housing 1 in the first preferred embodiment. Thus, a thickness of an electronic device provided with the speaker system 100 can be relatively reduced.

Referring to FIG. 13, a third preferred embodiment of the speaker system 100 according to the present invention is similar to the first preferred embodiment. In the third preferred embodiment, the radiator segment 3 of the antenna 40 is embedded in the cover component 12 of the housing 1 such that the antenna 40 is hidden by the housing 1 for preserving the appearance of the speaker unit 30.

In summary, by virtue of the speaker device 20 that includes the antenna 40 integrated with the speaker unit 30, the space for other electronic modules on the circuit board 10 is increased and the thickness of the electronic device provided with the speaker system 100 can be reduced. Further, wiring layout on the circuit board 10 is relatively simpler, and manufacturing costs can be decreased. Also, the performance of the antenna 40, such as the antenna gain and the omni-directionality thereof, can be maintained.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A speaker device comprising:
a speaker unit for generating an audio output; and
an antenna directly mounted on said speaker unit for radiating and receiving radio waves.

2. The speaker device as claimed in claim 1, wherein said speaker unit includes a housing formed with a hole portion, and an audio output module disposed in said housing and exposed from said hole portion for generating the audio output, said antenna being directly mounted on an outer surface of said housing.

3. The speaker device as claimed in claim 2, wherein said housing includes a top wall formed with said hole portion, and said antenna is directly mounted on an outer surface of said top wall and is disposed to surround at least a portion of said hole portion.

4. The speaker device as claimed in claim 2, wherein said housing includes a peripheral wall portion, and said antenna is directly mounted on an outer surface of said peripheral wall portion and surrounds said peripheral wall portion.

5. The speaker device as claimed in claim 1, wherein said speaker unit includes a base component, and an audio output module disposed on said base component for generating the audio output, said antenna being directly mounted on said audio output module.

6. The speaker device as claimed in claim 1, wherein said speaker unit includes a housing formed with a hole portion, and an audio output module disposed in said housing and exposed from said hole portion for generating the audio output, said antenna being embedded in said housing.

7. The speaker device as claimed in claim 1, wherein said antenna includes a radiator segment that is directly mounted on said speaker unit and that surrounds at least a portion of said speaker unit.

8. The speaker device as claimed in claim 7, wherein:
said speaker unit includes a base component, and an audio output module disposed on said base component for generating the audio output; and
said antenna further includes
a feed-in segment having a connection end electrically connected to said radiator segment, and a feed-in end opposite to said connection end and extending toward said base component, and
a grounded segment spaced apart from and extending parallel to said feed-in segment, and having a connection end electrically connected to said radiator segment and a grounded end extending toward said base component.

9. The speaker device as claimed in claim 7, wherein said radiator segment is substantially formed into a loop.

10. The speaker device as claimed in claim 9, wherein said radiator segment includes a first radiator section extending in a first direction, a second radiator section extending from one end of said first radiator section in a second direction substantially transverse to said first radiator section, a third radiator section extending from one end of said second radiator section opposite to said first radiator section and substantially parallel to said first radiator section, and a fourth radiator section extending from one end of said third radiator section opposite to said second radiator section and substantially parallel to said second radiator section, said first and fourth radiator sections having distal ends spaced apart from each other.

11. The speaker device as claimed in claim 1, wherein said antenna is a planar antenna.

12. A speaker system comprising:
a circuit board; and
a speaker device disposed on said circuit board, and including a speaker unit for generating an audio output and an antenna directly mounted on said speaker unit for radiating and receiving radio waves.

13. The speaker system as claimed in claim 12, wherein said circuit board includes a bonding pad, an inductor electrically connected to said bonding pad for configuring a resonance point of the audio output generated by said speaker unit of said speaker device, and a control unit electrically connected to said inductor for generating an audio signal,
said speaker unit being electrically connected to said bonding pad for receiving the audio signal from said control unit so as to generate the audio output.
